(19) United States
(12) Patent Application Publication
(10) Pub. No.: US 2017/0110218 A1
(43) Pub. Date: Apr. 20, 2017

(54) WIRE HARNESS

(71) Applicant: SUMITOMO WIRING SYSTEMS, LTD., Mie (JP)

(72) Inventors: Masataka WAKABAYASHI, Mie (JP); Shota ARAGIRI, Mie (JP)

(73) Assignee: SUMITOMO WIRING SYSTEMS, LTD., Mie (JP)

(21) Appl. No.: 15/282,115

(22) Filed: Sep. 30, 2016

(30) Foreign Application Priority Data
Oct. 20, 2015 (JP) 2015-206604

(51) Int. Cl. H01B 7/00; H01R 13/52; H01R 4/18; H01R 9/24; H02G 15/06; H02G 15/04

(52) U.S. Cl. CPC H01B 7/0045; H02G 15/06; H02G 15/04; H01R 4/185; H01R 9/2416; H01R 13/521

(57) ABSTRACT

A wire harness includes a plurality of coated electric wires; a connector terminal including a connection portion, a first barrel portion, and a second barrel portion; a connector configured to lock and store the connection portion; a rubber seal including a small-diameter tubular portion, a middle tubular portion having a spiral contour, and a large-diameter tubular portion, where the small-diameter tubular portion is secured by the second barrel portion along with an end portion of the insulation coating material. The middle tubular portion and the large-diameter tubular portion are force-fitted into a terminal insertion hole, and a rear holder is secured to the connector with the rubber seal pressed toward the terminal insertion hole, compressing the middle tubular portion axially. A waterproofing agent is applied to an outer surface of the middle tubular portion and is cured filling gaps between the middle tubular portion and the terminal insertion hole.

### CROSS-REFERENCE TO RELATED APPLICATIONS

The present application claims priority under 35 U.S.C. §119 of Japanese Application No. 2015-206604, filed on Oct. 20, 2015, the disclosure of which is expressly incorporated by reference herein in its entirety.

### BACKGROUND OF THE INVENTION

1. Field of the Invention

The present invention relates to a wire harness, and specifically to a watertight wire harness used for connecting electric wires in vehicles and the like.

2. Description of Related Art

Conventionally, a connector housing accommodates electric wires in a connector. A rubber plug is placed over the electric wires at an entrance to the connector housing and the assembly is retained in a rear holder to make the connector housing more waterproof.

The area around the rear holder and electric wire is filled with a sealant such as grease, or the like, to further improve the waterproofness of this kind of connector (see for instance, Japanese Patent Laid-open Publication No. H07-135044).

Japanese Patent Laid-open Publication No. H07-135044 discloses a connector provided with terminal fittings having wire connection portions, a rear holder B, a connector housing A having internal terminal housing chambers, and a waterproof plug C (refer to FIG. 10). Electric wires W are threaded through insertion holes in the waterproof plug C and in the rear holder B. The wire connection portions of the terminal fittings are connected to the end portions of the electric wires W and are fitted into the rear holder B. The terminal fittings are housed in the terminal housing chambers and the rear holder B is secured by a locking piece behind the terminal housing chambers in the connector housing A. Finally, the connector housing A and the waterproof plug C are fitted together and the connector housing A is filled with a sealant E. A connector with this configuration exhibits improved waterproofness.

Despite that, with the connector described in Japanese Patent Laid-open Publication No. H07-135044, when a vehicle is pressure washed, for instance, high-pressure water can invade the connector through gaps between the sealant E and the connector housing A. Thus further improvements to the waterproofness of the connector are required.

### SUMMARY OF THE INVENTION

In light of the forgoing circumstance, aspects of the present invention provide a wire harness that can remain waterproof even when pressure washing a vehicle.

In order to achieve this, a wire harness according to the present invention is provided with a plurality of coated electric wires with an insulation coating material thereon stripped to expose a conductor end portion; a connector terminal including a connection portion, a first barrel portion, and a second barrel portion provided so that the first barrel portion secures the conductor end portion, and the second barrel portion secures an end portion of the remaining insulation coating material; a connector including a plurality of terminal insertion holes and configured to lock and store the connection portion of the connector terminal in place in each of the terminal insertion holes; a rubber seal made from a molded rubber component to include, in order, a small-diameter tubular portion with a diameter smaller than the terminal insertion hole, a middle tubular portion having a spiral contour, and a large-diameter tubular portion and, in a state where the coated electric wires are inserted in each of the terminal insertion holes, the small-diameter tubular portion is secured by the second barrel portion along with the end portion of the remaining insulation coating material and the middle tubular portion and the large-diameter tubular portion are force-fitted into the terminal insertion hole; and a rear holder secured to the connector in a state where an end face of the rubber seal near the large-diameter tubular portion is pressed toward the terminal insertion hole, compressing the middle tubular portion axially. A curable waterproofing agent applied to an outer surface of the middle tubular portion at the time of assembly is cured filling gaps in between the middle tubular portion and the terminal insertion hole.

With this configuration, in a wire harness according to this aspect of the present invention, when the rear holder is secured to the connector, the rear holder presses the end surface of the rubber seal near the large-diameter tubular portion toward the terminal insertion hole, compressing the middle tubular portion axially; therefore, the waterproofing agent applied to the grooves in the spiral contour of the middle tubular portion fills interior space between the middle tubular portion and the terminal insertion hole. Thereby, the waterproofing agent filling the spaces prevents the intrusion of water, and makes it difficult for water to enter from outside. Therefore it is possible for the wire harness to remain waterproof when pressure washing the vehicle.

The rear holder in a wire harness with the above configuration can include a slit through which the plurality of coated electric wires are inserted, the slit having a slit width slightly larger than a diameter of the coated electric wires, with one side of the slit including a rubber seal through-hole through which the middle tubular portion and the large-diameter tubular portion pass.

With this configuration, the rear holder includes a rubber seal through-hole at one end of the slit, through which the middle tubular portion and the large-diameter tubular portion can pass. Therefore, the rubber seal can be attached to the coated electric wire before passing the coated electric wire through the slit in the rear holder. This does not mean that the rubber seal cannot be attached to the coated electric wire after passing the coated electric wire through the slit in the rear holder. Accordingly, this improves flexibility in a task of attaching the rubber seal to the coated electric wire.

Aspects of the present invention provide a wire harness that can remain waterproof even when pressure washing a vehicle.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating a wire harness according to a first embodiment of the present invention, before attaching a rear holder;

FIG. 2 is a vertical cross-sectional view illustrating the wire harness according to the first embodiment of the present invention, before attaching the rear holder;

FIG. 3 is a schematic view of a rubber seal used in the wire harness according to the first embodiment of the present invention;

FIG. 4 is a perspective view illustrating the wire harness according to the first embodiment of the present invention, after attaching the rear holder;

FIG. 5 is a vertical cross-sectional view illustrating the wire harness according to the first embodiment of the present invention, after attaching the rear holder;

FIG. 6 is a perspective view illustrating a wire harness according to a second embodiment of the present invention, before attaching a rear holder;

FIG. 7 is a perspective view illustrating the wire harness according to the second embodiment of the present invention, after attaching the rear holder;

FIG. 8 is a front view illustrating a shape of a slit in the rear holder of the wire harness according to the second embodiment of the present invention;

FIGS. 9A to 9D are perspective views of how a rubber seal is attached to coated electric wires in the wire harness according to the second embodiment of the present invention; and

FIG. 10 is a cross-sectional view of a conventional wire harness.

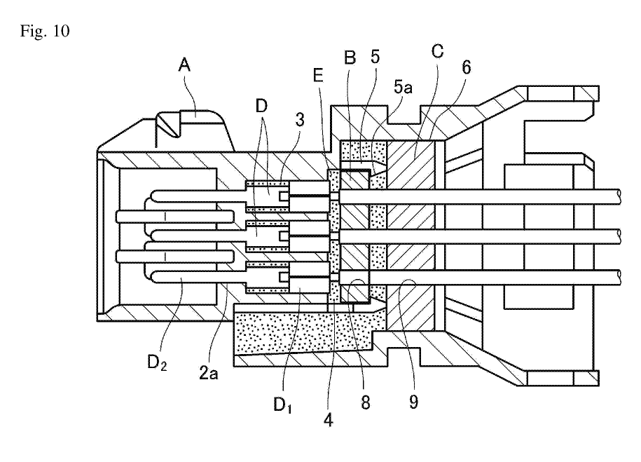

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

A wire harness according to embodiments of the invention is described below with reference to the drawings.

### First Embodiment

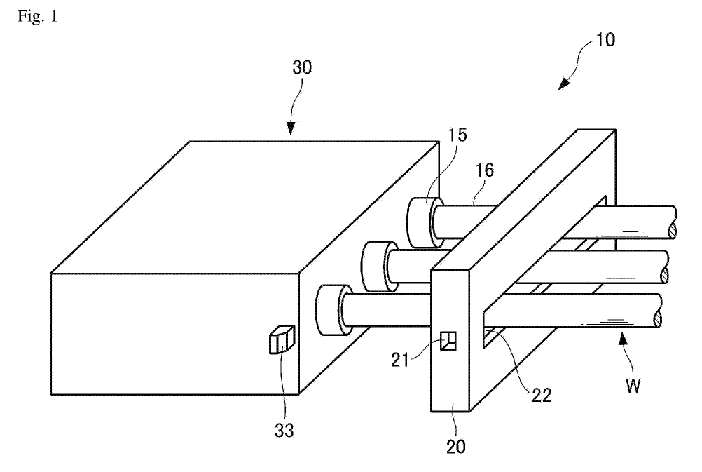

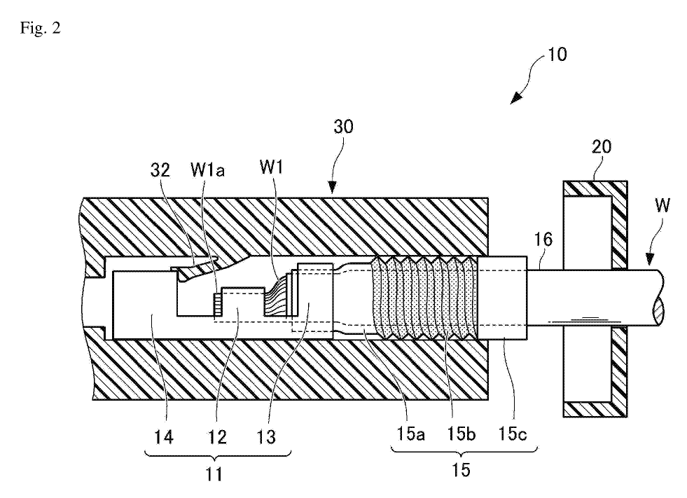

FIG. 1 illustrates a wire harness according to a first embodiment; FIG. 1 is a perspective view illustrating a state before a rear holder is attached to a connector. FIG. 2 is a cross-sectional view of an inside of the connector before the rear holder is attached to the connector.

As illustrated in FIG. 1, a wire harness 10 is provided with a plurality of coated electric wires W, a connector terminal 11, a connector 30, a rubber seal 15, and a rear holder 20.

As illustrated in FIG. 2, a coated electric wire W is covered with an insulation coating material 16 such as PVC, or the like. However, the insulation coating material 16 is stripped from the coated electric wire W beforehand from a portion of the coated electric wire W to be connected to the connector terminal 11. This exposes a conductor end portion W1a of a conductor W1, which is a bundle of small-diameter copper wires. More specifically, an end portion of the insulation coating material 16 is stripped off to expose the conductor W1; for example, 10 to 15 mm of the end portion may be stripped off. The conductor W1 may be a single large-diameter copper wire. The conductor W1 may also be an aluminum wire.

The connector terminal 11 includes a connection portion 14, a first barrel portion 12, and a second barrel portion 13. The connection portion 14 is cylindrical and is formed as a female connector; however the connection portion 14 may be formed as a male connector. The connection portion 14 makes contact with a lock piece 32 and is locked and stored in place inside a terminal insertion hole 31. The connector terminal 11 is provided at the end portion of each of the coated electric wires W toward the insertion direction. The connector terminal 11 may be a molded component machined from a suitably conductive metal sheet of one of, for example, copper, (tin-electroplated) oxygen-free copper, brass, and aluminum alloy.

Before assembly with the coated electric wire W, the first barrel portion 12 and the second barrel portion 13 each include a pair of open flat pieces, provided on two sides of each member, that are wrapped around the coated electric wire W via a swage tool. The first barrel portion 12 is provided to secure the conductor end portion W1a. The second barrel portion 13 is provided to secure the end portion 16a of the remaining insulation coating material 16. Thus, the first barrel portion 12 is shaped to wrap around and secure the conductor W1, and the second barrel portion 13 is shaped to wrap around and secure the end portion 16a of the remaining insulation coating material 16. The connector terminal 11 thereby secures the coated electric wire W.

The connector 30 includes a plurality of terminal insertion holes 31 and a lock-projection portion 33. A lock piece 32 is provided on an interior surface of each of the terminal insertion holes 31 so that when a connection portion 14 makes contact, the connection portion 14 of the connector terminal 11 is locked and stored in place inside the terminal insertion hole 31. More specifically, the connection portion 14 pushes down the lock piece 32 when passing the lock piece 32; the lock piece 32 then returns to its protruding position, abutting a rear end of the connection portion 14 in the insertion direction and ensuring that the connection portion 14 is locked and stored in place.

The connector 30 may, for example, be an injection molded component made from a liquid crystal polymer (LCP) resin that is excellent for precision molding and highly heat-resistant, with a glass fiber (GF) or inorganic filler dispersed throughout to relax anisotropic properties of the polymer. The connector 30 can also be produced from a resin such as polyester, polyamide, polypropylene, polyethylene, or the like. The connector 30 may also be injection molded from reinforced polyethylene terephthalate resin with GF and inorganic filler dispersed throughout.

As illustrated in FIG. 1, the lock-projection portion 33 is provided to protrude from an outer side surface of a main part of the connector 30, to fit into a lock-recess portion 21 on the rear holder 20 when the connector 30 is secured to the rear holder 20 (later described).

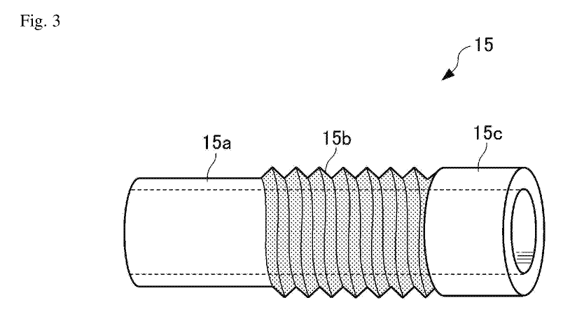

FIG. 3 is a detailed schematic view of the rubber seal 15 used in the wire harness 10 according to the first embodiment of the present invention. As illustrated in FIG. 3, the rubber seal 15 is a molded rubber component including a small-diameter tubular portion 15a, a middle tubular portion 15b, and a large-diameter tubular portion 15c. The rubber seal 15 is attached to a portion of the outer circumference of the coated electric wire W. The rubber seal 15 is configured, in this order from a tip end of the coated electric wire W, as the small-diameter tubular portion 15a, the middle tubular portion 15b, and the large-diameter tubular portion 15c.

The small-diameter tubular portion 15a is configured to have a diameter that allows the small-diameter tubular portion 15a to be inserted into the terminal insertion hole 31; that is, the diameter of the small-diameter tubular portion 15a is smaller than the size of the inner portion of the terminal insertion hole 31. The middle tubular portion 15b has a spiral contour, and is configured to have a diameter that is slightly larger than the diameter of the small-diameter tubular portion 15a. The outer surface of the middle tubular portion 15b is coated with a waterproofing agent such as urethane. The urethane agent is curable, and may be applied when the coated electric wire W and the rubber seal 15 are assembled together. While the present embodiment uses urethane as the waterproofing agent, other agents capable of stopping water, such as grease or silicon, may be used. The large-diameter tubular portion 15c is a cylindrical component with an outer diameter that is substantially equivalent to the diameter of the middle tubular portion 15b.

The middle tubular portion 15b is configured with a spiral contour to improve waterproofing. A waterproofing agent applied to the middle tubular portion 15b enters the gaps in the spiral. When assembling the rubber seal 15 and the rear holder 20 together (later described), the rubber seal 15, including the middle tubular portion 15b, is pressed and deformed in the insertion direction. Consequently, the waterproofing agent is pushed out of the gaps in the spiral and fills inside the terminal insertion hole 31.

When the coated electric wires W are inserted into the terminal insertion holes 31, as illustrated in FIG. 2, the second barrel portion 13 secures the small-diameter tubular portion 15a of the rubber seal 15 along with the end portion 16a of the remaining insulation coating material 16. The middle tubular portion 15b and the large-diameter tubular portion 15c are force-fitted into the terminal insertion hole 31.

The rear holder 20 is box-shaped with a C-shaped cross-section. The rear holder 20 includes a lock-recess portion 21 and a slit 22. The size of the opening in the C-shaped cross-section of the rear holder 20 is larger than the contour size of the connector 30, allowing the rear holder 20 to cover the connector 30 from the outside when securing the rear holder 20 to the connector 30.

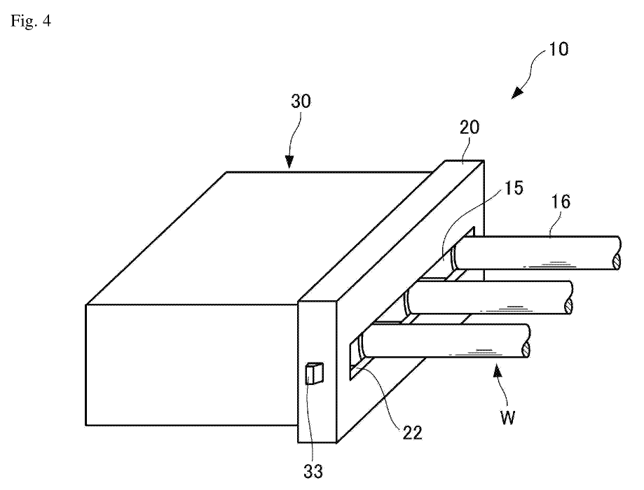

The lock-recess portion 21 fits into the lock-projection portion 33 on the connector 30 when the rear holder 20 is secured to the connector 30 (see FIG. 4). The rear holder 20 is provided with the slit 22 into which the coated electric wire W is inserted; the slit is made slightly wider (taller) than the coated electric wire W. In this embodiment the slit width of the slit 22 is narrower than the large-diameter tubular portion 15c in the rubber seal 15.

To attach the rear holder 20 to the connector 30, first, the coated electric wire W is inserted into the slit 22 in the rear holder 20. The rubber seal 15 and the connector terminal 11 are attached to the coated electric wire W, and the coated electric wire W is then inserted into the terminal insertion hole 31 of the connector 30. The coated electric wire W is first inserted into the slit 22 of the rear holder 20 in this embodiment because the coated electric wire W will not pass through the slit 22 after the rubber seal 15 and the connector terminal 11 are attached to the coated electric wire W, since the rubber seal 15 and the connector terminal 11 are larger than the width of the slit 22.

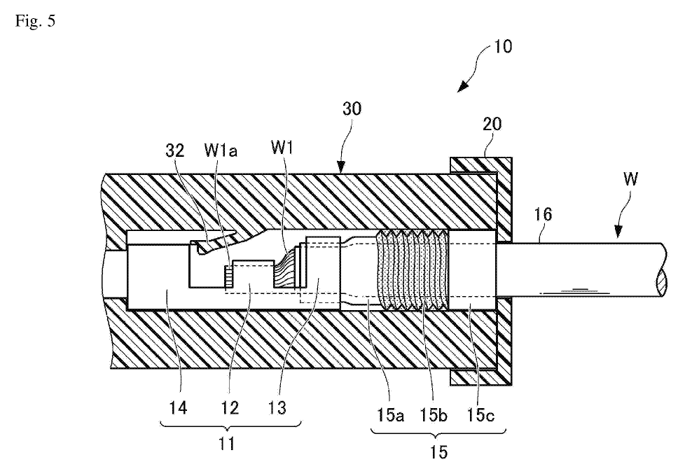

The wire harness 10 with the rear holder 20 attached according to this embodiment is described with reference to FIGS. 4 and 5. FIG. 4 is a perspective view, after the rear holder 20 is attached to the connector 30; and FIG. 5 is a cross-sectional view of inside the connector 30 after the rear holder 20 is attached to the connector 30.

As illustrated in FIG. 4, the rear holder 20 is configured so that fitting the lock-projection portion 33 into the lock-recess portion 21 attaches and secures the rear holder 20 to the connector 30 with the end surface of the rubber seal 15 near the large-diameter tubular portion 15c pressed toward the insertion direction of the terminal insertion hole 31, compressing the middle tubular portion 15b axially.

The urethane agent applied to the grooves in the spiral contour of the middle tubular portion 15b is squeezed out from the grooves and fills the terminal insertion hole 31 because the middle tubular portion 15b is compressed axially when the rear holder 20 is attached to the connector 30 as illustrated in FIG. 5. The urethane agent is then cured after the urethane agent fills the gaps between the middle tubular portion 15b and the terminal insertion hole 31.

After securing the rear holder 20 to the connector 30, the urethane agent is more easily cured by using a dryer, for instance, to heat the urethane agent through the gaps in the slit 22. The urethane agent is hardened to further discourage water from entering from outside the assembly.

As above described, the wire harness 10 according to aspects of the present embodiment is provided with the plurality of coated electric wires W with the insulation coating material 16 thereon stripped to expose the conductor end portion W1a; the connector terminal 11 including the connection portion 14, the first barrel portion 12, and the second barrel portion 13 provided so that the first barrel portion 12 secures the conductor end portion W1a, and the second barrel portion 13 secures the end portion 16a of the remaining insulation coating material 16; the connector 30 including terminal insertion holes 31, the lock piece 32, and the lock-projection portion 33, and configured to lock and store the connection portion 14 of the connector terminal 11 in place in each of the terminal insertion holes 31 with the lock piece 32; the rubber seal 15 made from a molded rubber component to include, in order, the small-diameter tubular portion 15a with a diameter smaller than the terminal insertion hole 31, the middle tubular portion 15b having a spiral contour, and the large-diameter tubular portion 15c and, in a state where the coated electric wires W are inserted in each of the terminal insertion holes 31, the small-diameter tubular portion 15a is secured by the second barrel portion 13 along with the end portion 16a of the remaining insulation coating material 16 and the middle tubular portion 15b and the large-diameter tubular portion 15c are force-fitted into the terminal insertion hole 31; and the rear holder 20 secured to the connector 30 by joining together the lock-recess portion 21 and the lock-projection portion 33 with the end face of the rubber seal 15 near the large-diameter tubular portion 15c pressed toward the terminal insertion hole 31, compressing the middle tubular portion 15b axially. The curable urethane agent applied to the outer surface of the middle tubular portion 15b at the time of assembly is cured filling the gaps in between the middle tubular portion 15b and the terminal insertion hole 31.

Additionally, the urethane agent is also heated and thereby cured, after the rear holder 20 is secured to the connector 30.

With this configuration, when the rear holder 20 is secured to the connector 30 in the wire harness 10, the rear holder 20 presses the end surface of the rubber seal 15 near the large-diameter tubular portion 15c toward the terminal insertion hole 31, compressing the middle tubular portion 15b axially. Consequently, the urethane agent applied to the grooves in the spiral contour of the middle tubular portion 15b fills interior space between the middle tubular portion 15b and the terminal insertion hole 31. Thereby, the urethane agent filling the spaces prevents the intrusion of water, and makes it difficult for water to enter from outside. Therefore it is possible for the wire harness to remain waterproof when pressure washing the vehicle.

After the rear holder 20 is secured to the connector 30, the urethane agent is heated via gaps in the slit 22 to cure the urethane agent. Therefore, this further facilitates preventing water from entering from outside and improves the watertight nature of the wire harness.

### Second Embodiment

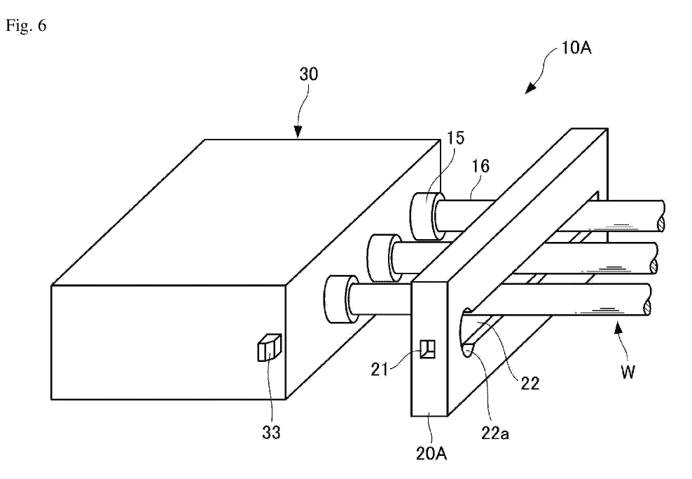

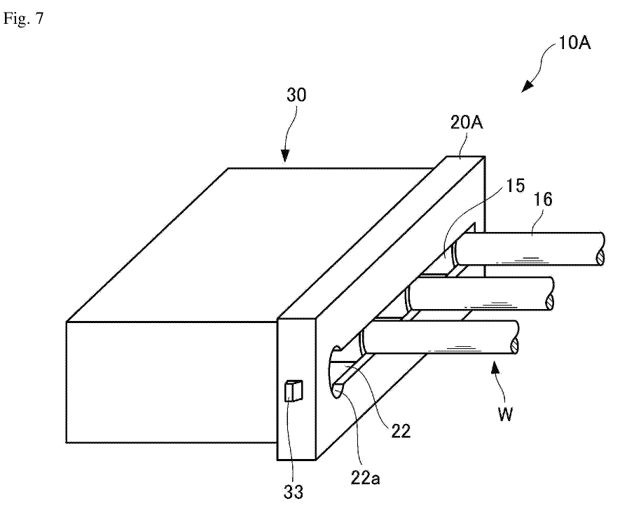

FIGS. 6 and 7 illustrate a wire harness 10A according to a second embodiment of the present invention, before and after attaching a rear holder 20A, respectively. The only difference between the wire harness 10A and the wire harness 10 is that the rear holder 20 according to the first embodiment is different from the rear holder 20A. All other components are given the same reference numerals as in the first embodiment. A description of the configuration, function, and effects of the same components is omitted.

The rear holder 20A includes a slit 22 slightly wider than the diameter of the coated electric wire W and through which a plurality of coated electric wires W are inserted. Moreover, at one side of the slit 22 in the rear holder 20A a rubber seal through-hole 22a is provided through which the middle tubular portion 15b and the large-diameter tubular portion 15c of the rubber seal 15 can pass.

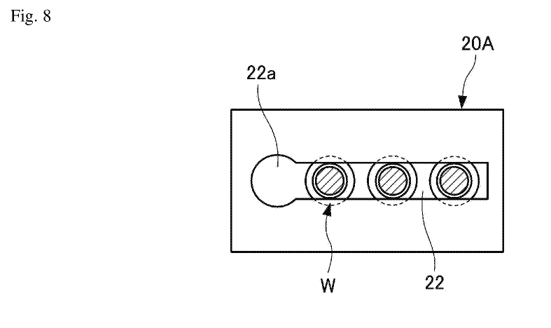

FIG. 8 is a front view illustrating the shape of the slit 22 in the rear holder 20A according to the second embodiment of the present invention. As illustrated in FIG. 8, the slit width of the slit 22 is wider (taller) than the diameter of the coated electric wire W and narrower (shorter) than the diameter of the rubber seal 15. In contrast, the diameter of the rubber seal through-hole 22a is larger than the diameter of the rubber seal 15. Providing a rubber seal through-hole 22a of such a diameter improves flexibility of the attachment process because the coated electric wire W can pass through the rear holder 20A while the rubber seal 15 and the connector terminal 11 are already attached to the coated electric wire W.

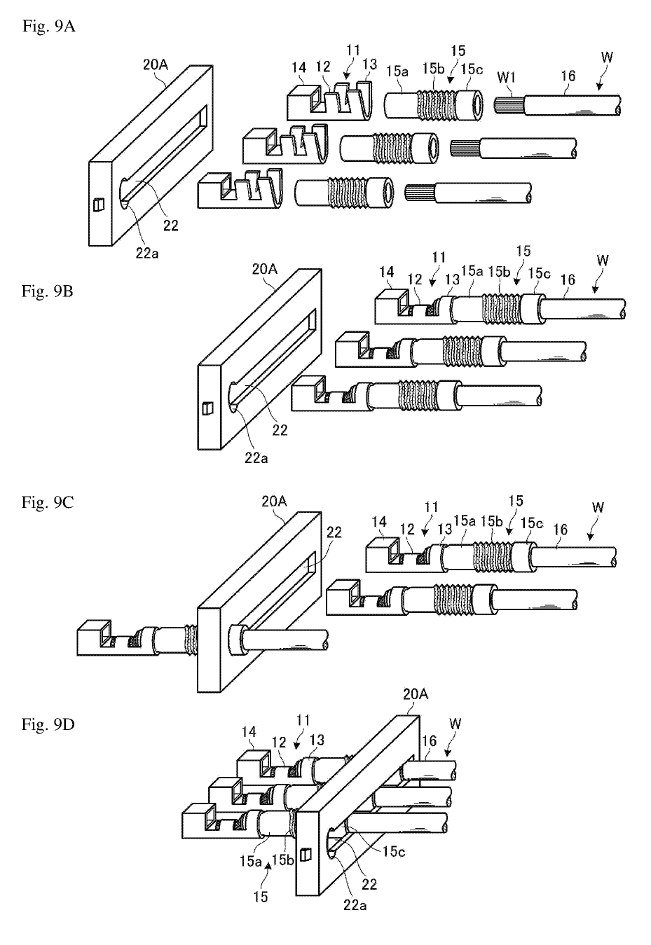

A procedure for attaching the rubber seal 15 to the coated electric wire W of the wire harness 10 according to the embodiment is described using FIGS. 9A to 9D.

FIG. 9A illustrates the coated electric wire W before attachment of the rubber seal 15 and the connector terminal 11. As illustrated in FIG. 9B, the rubber seal 15 and the connector terminal 11 are attached to the coated electric wire W before the coated electric wire W is passed through the slit 22 in the rear holder 20A.

Next, as illustrated in FIG. 9C, the coated electric wire W, with the rubber seal 15 and the connector terminal 11 already attached, is passed through the rubber seal through-hole 22a, which has a larger diameter than the diameter of the rubber seal 15. As illustrated in FIG. 9D, the coated electric wire W is then shifted laterally in the slit 22 toward the side opposite the rubber seal through-hole 22a. The steps in FIG. 9A to FIG. 9D are repeated for each coated electric wire W, so that a plurality of coated electric wires W can pass through the slit 22 in the rear holder 20A.

As above described, in the wire harness 10 according to the present embodiment, the slit 22 in the rear holder 20A has a slit width that is slightly larger than the diameter of the coated electric wire W, and a plurality of coated electric wires W are inserted through the slit 22. Moreover, one side of the slit 22 includes the rubber seal through-hole 22a through which the middle tubular portion 15b and the large-diameter tubular portion 15c can pass.

With this configuration, the rear holder 20A includes at one side of the slit 22 the rubber seal through-hole 22a, through which the middle tubular portion 15b and the large-diameter tubular portion 15c of the rubber seal 15 can pass. Therefore, the rubber seal 15 and the connector terminal 11 can be attached to the coated electric wire W at one of before and after passing the coated electric wire W into the slit 22 in the rear holder 20A. Thus, the method of attachment can be selected in accordance with the work environment. Accordingly, this improves the flexibility in attaching the rubber seal 15 and the connector terminal 11 to the coated electric wire W.

Note that the technical scope of a wire harness according to aspects of the present invention is not limited to the embodiments described above and includes various modifications to the constituent elements described in the claims.

As above described, a wire harness according to aspects of the present invention remains watertight even when pressure washing a vehicle, and is applicable wherever wire harnesses are typically used.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness comprising:
a plurality of coated electric wires having an insulation coating material thereon stripped to expose a conductor end portion;
a connector terminal including a connection portion, a first barrel portion, and a second barrel portion configured so that the first barrel portion secures the conductor end portion of one of the electric wires, and the second barrel portion secures an end portion of the remaining insulation coating material;
a connector including a plurality of terminal insertion holes and configured to lock and store the connection portion of the connector terminal in each of the terminal insertion holes;
a rubber seal including a small-diameter tubular portion with a diameter smaller than the terminal insertion hole, a middle tubular portion having a spiral contour, and a large-diameter tubular portion, wherein when the coated electric wires are inserted in each of the terminal insertion holes, the small-diameter tubular portion is secured by the second barrel portion along with the end portion of the remaining insulation coating material and the middle tubular portion and the large-diameter tubular portion are force-fitted into the terminal insertion hole; and
a rear holder secured to the connector in a condition in which an end face of the rubber seal near the large-diameter tubular portion is pressed toward the terminal insertion hole, compressing the middle tubular portion axially; wherein
a curable waterproofing agent applied to an outer surface of the middle tubular portion is cured filling gaps between the middle tubular portion and the terminal insertion hole.

2. The wire harness according to claim 1, wherein the rear holder further includes a slit through which the plurality of coated electric wires are inserted, the slit having a slit width slightly larger than the diameter of the coated electric wires, with one side of the slit including a rubber seal through-hole through which the middle tubular portion and the large-diameter tubular portion pass.
